(19) United States
(12) Patent Application Publication
(10) Pub. No.: US 2012/0068925 A1
(43) Pub. Date: Mar. 22, 2012

(54) SYSTEM AND METHOD FOR GESTURE BASED CONTROL

(75) Inventors: Ling Jun Wong, Escondido, CA (US); True Xiong, San Diego, CA (US)

(73) Assignee: Sony Corporation, Tokyo (JP)

(21) Appl. No.: 12/887,405

(22) Filed: Sep. 21, 2010

(51) Int. Cl. G06F 3/033

(52) U.S. Cl. 345/158

(57) ABSTRACT

Methods and apparatus are provided for gesture based control of a device. In one embodiment, a method includes detecting a first position sensor signal, the first position sensor signal detected by a first sensor, and detecting a second position sensor signal, the second position sensor signal detected by a second sensor, wherein the second position sensor signal is based on position of the second sensor relative to the first sensor. The method may further include generating a control signal for a device based on the first and second position sensor signals, wherein the first and second position sensor signals are generated based on user positing of the first and second sensors. The method may further include transmitting the control signal to the device.

### FIELD

The present disclosure relates generally to input devices, and more particularly to a system and methods for gesture based control.

### BACKGROUND

The mainstream method of navigating and operating a television is via a remote control. Typically, remote controls transmit optical commands to a television based on a user pressing one or more buttons of the remote control. Some of the televisions operating commands are well suited for a traditional remote control. However, many televisions and display devices in general allow for display of content which is not well suited by the traditional directional keys for volume, channel, and directional adjustment. What is desired is a solution that allows for providing gesture based commands for a display device.

### SUMMARY OF EMBODIMENTS

Disclosed and claimed herein are methods and apparatus for gesture based control. In one embodiment, a method includes detecting a first position sensor signal, the first position sensor signal detected by a first sensor, and detecting a second position sensor signal, the second position sensor signal detected by a second sensor, wherein the second position sensor signal is based on position of the second sensor relative to the first sensor. The method further includes generating a control signal for a device based on the first and second position sensor signals, wherein the first and second position sensor signals are generated based on user positing of the first and second sensors. The method further includes transmitting the control signal to the device.

Other aspects, features, and techniques of the disclosure will be apparent to one skilled in the relevant art in view of the following detailed description of the disclosure.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a simplified system diagram according to one or more embodiments;

FIG. 2 depicts a process for providing gesture based control of a device according to one embodiment;

FIG. 3 depicts a simplified block diagram of a device according to one embodiment;

FIG. 4 depicts a graphical representation of the device of FIG. 3 according to one embodiment;

FIG. 5 depicts a process according to one embodiment;

FIG. 6 depicts a process for transmitting commands according to one embodiment;

FIGS. 7A-7B depict a graphical representations for gesture based control according to one embodiment;

FIGS. 8A-8B depict a graphical representations for gesture based control according to another embodiment;

FIG. 9 depicts a graphical representation for gesture based control according to another embodiment;

FIG. 10 depicts a graphical representation of gesture based control according to another embodiment;

FIGS. 11A-11B depict a graphical representations for gesture based control according to another embodiment;

FIGS. 12A-12B depict a graphical representations for gesture based control according to another embodiment; and

FIG. 13 depicts a graphical representation of a user device according to one embodiment.

### DETAILED DESCRIPTION OF THE EMBODIMENTS

### Overview and Terminology

One embodiment relates to providing gesture based control. In one embodiment, a system and methods are provided for a user to communicate with a device using one or more gesture based controls associated with a first and second sensor. In one embodiment, the first and second sensor may be associated with a first and second device, respectively. Accordingly, user positioning of the first and second sensors may be employed to generate one or more control signals for transmission to a device, such as a display device. In one embodiment, a process is provided for gesture based control based on positioning data associated with a first sensor device and the second sensor device. The process may include determining control signals based on comparison of the user movement of the first and second sensors to established commands. In one embodiment, user motioning of first and second devices with a particular shape may correspond to a particular command. According to another embodiment, the process may correlate user motion of one sensor relative to a second sensor to generate a command.

According to another embodiment, a system is provided for gesture based control of a device. For example, the system may relate to gesture based control of a display device based on one or more control signals generated by a first input source. The system may be configured to control operation of a display device wirelessly based on one or more position signals detect by a first input source and a second input source.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment of the present disclosure. Thus, the appearances of such phrases in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, the disclosure is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the disclosure are essentially the code segments to perform the necessary tasks. The code segments can be stored in a processor readable medium, which may include any medium that can store or transfer information. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

### Exemplary Embodiments

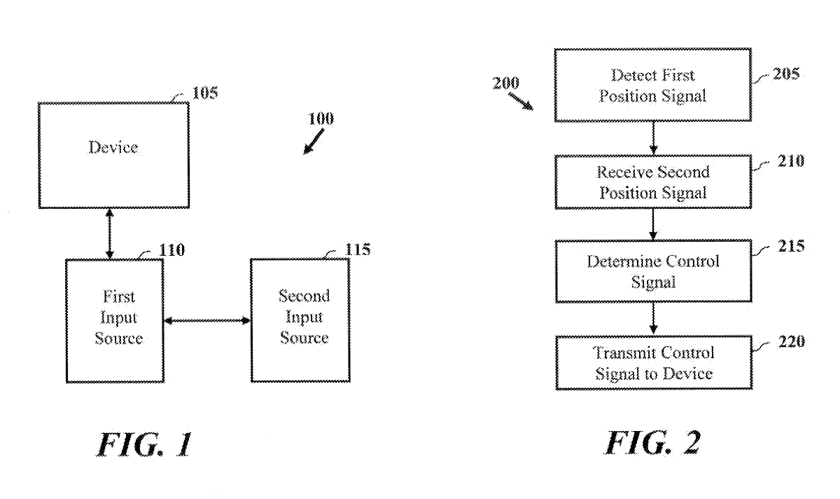

Referring now to the figures, FIG. 1 depicts a simplified system diagram according to one or more embodiments. In one embodiment, system 100 may be provided for providing gesture based input to a device. In particular, system 100 may be employed to provide one or more control signals for device 105 based on positioning detected by at least one sensor. Device 105 may relate to a display device (e.g., a TV, computer, media player, etc.). According to one embodiment, device 105 may be configured to communicate with first input source 110.

According to another embodiment, first input source 110 and second input source 115 may be configured to provide a control signal based on a user gesture. First input 110 source may relate to a first device configured to detect user positioning, wherein the first device includes a first sensor to detect positioning of the first device. First input source 110 may be configured for communication with second input source 115. Second input source 115 may relate to a second device configured to detect user positioning. Based on user positioning of second input source 115, the second input source may transmit one or more signals to first input source 110. For example, second input source 115 may be configured to transmit a position sensor signal to first input source 110 based on positioning of a sensor associated with second input source and the first input source 110. First input source 110 may be configured to determine a control signal based on a position sensor detected by a first sensor and the second sensor. First input source 110 may additionally be configured to transmit the control signal to device 105.

According to one embodiment first input source 110 and second input source 115 may each relate to a separate ring device that may be configured to detect position and user motioning. A ring device as disclosed herein may include at least one position senor, such as a two-dimensional or three-dimensional sensor for example, for detecting user positioning.

First input source 110 may be configured for wireless communication with device 105 and second input source 115. System 100 may allow for wireless communication based on radio frequency (RF), infrared (IR), and short-range wireless communication (e.g., Bluetooth™, etc.).

Referring now to FIG. 2, a process is depicted for providing gesture based on control of a device. In one embodiment, process 200 may be employed by the first input source of FIG. 1. Process 200 may be initiated by a first sensor detecting a first position sensor signal at block 205. The first position sensor signal may relate to motion of the user. In one embodiment the first position sensor signal may relate to user motion relative to a device. For example, when the first sensor is associated with a wearable device, the first sensor may detect one or more user movements or gestures. The gestures may be relative to a device, such as a display device, and associated with user control signal.

According to another embodiment, a second sensor may detect user positioning of a second device. As described above, the second device may be configured to transmit a positioning signal to the first device. At block 210, a device associated with the first sensor may be configured to receive the second positioning signal. The second positioning signal may relate to user positioning of the second sensor relative to the first sensor. Position signals associated with a first and second sensor may be generated based on user positioning. For example, when the first and second sensors are associated with first and second devices wearable by a user, the positioning signals may relate to user gestures which may be detected for controlling a device.

Based on the first and second positioning signals, a first input source may be configured to determine a control signal for a device at block 215. According to one embodiment, control signals for a device may be generated based on positioning of one or more of a first and second sensor. For example, a control signal may be generated based on detecting position of the second sensor relative to the first sensor within a plane. According to another embodiment, the first and second sensors may be wearable by the user. By way of example, the first sensor may be wearable on a first digit of the user, while the second sensor wearable on a second digit of the user. In another embodiment, a control signal may be generated based on user positioning of at least one of the first and second sensors with a particular shape. A control signal may be generated based on user movement of the second sensor while the first sensor is in a fixed position. In another embodiment, a control signal may be generated based on user positioning of the first and second sensors in one of an outward and inward motion relative to each other.

Control signals may be transmitted to the device at block 220. In one embodiment, the control signal may be transmitted wirelessly from a device associated with the first sensor to the device to be controlled. In certain embodiments, based on transmission of a control signal, a device, such as a display device, may be configured to display an indication that the device has received the control signal and/or a graphical indication of the signal received. Further, in yet another embodiment, user tapping of a device associated with the first sensor may relate to a user input. Based on the user tapping, a control signal may be generated to control a device. For example, user tapping of a first device, such as a ring sensor device, may result in transmitting a command to turn on or off a display device.

Although, process 200 has been described above with reference to gesture based control of a device, it should be appreciated that other types of control and positioning may be provided based on process 200.

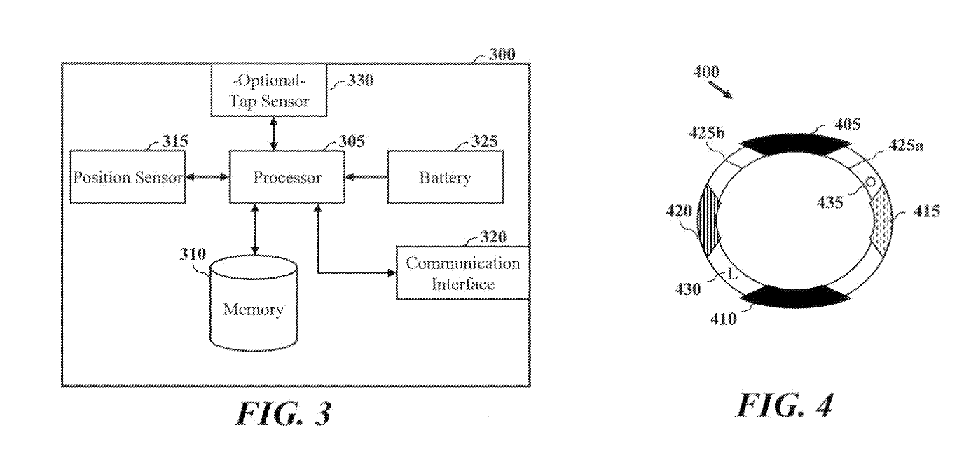

FIG. 3 depicts a simplified block diagram of a device according to one embodiment. In one embodiment, device 300 relates to first input source of FIG. 1. It should also be appreciated that second input source of FIG. 1 may include one or more elements as similarly described. Device 300 may be configured to detect position and transmit a control signal. As depicted in FIG. 3, device 300 includes processor 305, memory 310, position sensor 315, communication interface 320 and battery 325. Processor 305 may be configured to control operation of device 300 based on one or more computer executable instructions stored in memory 310. Memory 310 may relate to one of RAM and ROM memories and may be configured to store one or more media files, content, and computer executable instructions for operation of device 300. Processor 305 may additionally be configured to determine one or more control signals based on one or more position sensor signals detected by position sensor 315 and one or more signals received from a second input source (e.g., second sensor).

Position sensor 315 may relate to one or more of a two-dimensional and three-dimensional position sensor. In one embodiment, position sensor 315 may be configured to detect user position of device 300 to detect one or more gestures. Although depicted as a single sensor, it may be appreciated that position sensor 315 may relate to a plurality of position sensors. Position sensor 315 may be configured to provide a position sensor signal to processor 305 when device 300 is relatively still and when device 300 is manipulated by a user. In certain embodiments, processor 305 may be configured to approximate a positioning path and/or user motion based on position sensor output. When device 300 relates to a wearable ring, position sensor 315 may be configured to detect movement of a digit, finger, hand, or arm, may be detected.

Communication interface 320 may be configured to allow for wireless communication between device 300 and another device. According to another embodiment, communication interface 320 may allow for communication with another positioning sensing device (e.g., second input source 115). In certain embodiments communication interface 320 may employ separate communication elements for communication with a device (e.g., a display device) and another sensing device (e.g., second input source 115). Device 300 may further include a power source, such as a battery depicted as 325. In certain embodiments, device 300 may include one or more terminals for charging battery 325 of the device. For example, when device 300 relates to a ring device that may be wearable by a user, the ring device may include a terminal for coupling the ring device to a charging supply.

According to another embodiment device 300 may be configured to detect user tapping of the device. Based on user tapping, processor 305 may generate a control signal for a device. In certain embodiment, user tapping may be detected by position sensor 315. In other embodiments, device 300 may include optional tap sensor 330. Optional tap sensor may be configured to detect user tapping based on motion, a voltage drop and/or via photodetection (e.g., user covering the tap sensor).

Referring now to FIG. 4, a graphical representation is depicted of the device of FIG. 3 according to one embodiment. According to one embodiment, ring device 400 may be employed for detecting user positioning for gesture based control. As depicted, ring device 400 includes position sensor 405. Position sensor 405 may relate to an electro-mechanical device such as an accelerometer, or microelectromechanical systems (MEMS), for detecting one or more of two dimensional and three-dimensional positioning. In certain embodiments, ring device 400 may include additional sensors. A processor (e.g., processor 305) of the ring device is depicted as 410.

Ring device 400 may include a transceiver 415 for communication with another ring device (e.g., second input source 115). Transceiver 415 may be configured to receive a second position signal associated with a second sensor. Transceiver 420 may be configured to transmit one or more control signals to a device, such as a display device. In one embodiment, transceivers 415 and 420 may be configured for RF communication.

According to another embodiment, ring device 400 may include one or more markings to provide a user with an indication of a correct digit, or finger, for wearing and/or orientation. As depicted in FIG. 4, ring device 400 includes indicators 425a-425b to indicate a top portion of the ring device. Similarly, ring device 400 includes indicator “L” to indicate a left hand or finger for wear. It may be appreciated that a second input source operating in conjunction with ring device 400 may include similar indicators, including an indicator (e.g., “R” to identify a right digit or hand. Wearing the ring device in a particular orientation may assist in detection of positioning. According to another embodiment, ring device 400 may include optional sensor 435. Optional sensor 435 may be configured to detect user tapping of ring device 400. In one embodiment, optional sensor may relate to an optical sensor, wherein user tapping is detected based on optical energy detected.

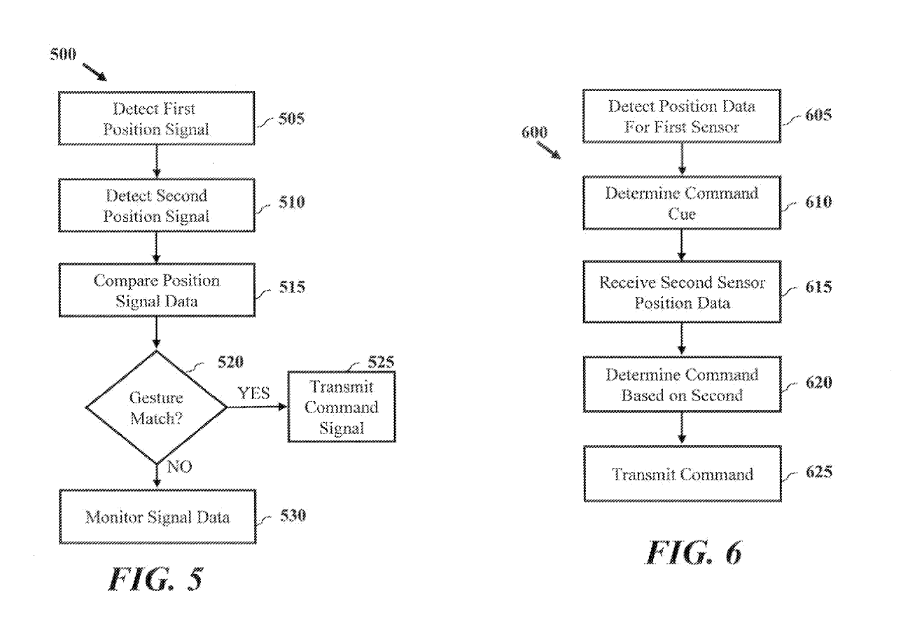

Referring now to FIG. 5, a process is depicted according to one embodiment. Process 500 may be employed by a device associated with a first sensor, such as first input source 110, for generating a control signal. Process 500 may be imitated at block 505 by detecting a first position signal. The first position signal may be detected by a first sensor associated with a first input source. At block 510 a second position signal may be detected. The second position signal may be associated with a second sensor associated with a second input source, for example. At block 515, the position signal data may be compared by the first sensor device. At block 520, the signal data may be checked to determine gesture match. When position signal data relates to a user gesture (e.g., “YES” path out of decision block 520), the device may transmit a commend signal at block 525. When position signal data does not relate to a user gesture (e.g., “NO” path out of decision block 520), the device may continue to monitor position signals at block 525. In certain embodiments, commands may be associated with gestures relating to movement of a first sensor followed by movement of a second position sensor. Accordingly process 500 may allow for multiple user movements to be detected for generating a command.

Referring now to FIG. 6, a process is depicted for transmitting commands according to one embodiment. According to one embodiment, user gestures may include cues for indicating that a command will be motioned. Process 600 may be employed for detecting a cue, and a gesture command. Process 600 may be initiated by detect position data associated with a first sensor (e.g., first input source) at block 605. In certain embodiments, user motion of a first sensor in a particular motion, such a down movement in a relatively vertical path may signal a cue. At block 610, the first sensor device may determine that a command cue has been motioned by the user. Once a user has motioned a cue, the user may then motion with a second sensor device to gesture a command.

At block 615, the first sensor device may receive second sensor position data. Based on the received position data, the first sensor device may determine a command at block 620. Based on the determined command, the first sensor device may transmit the command to a device. By way of example, a user wearing two ring shaped devices may employ motion to control a display device such as a TV. When the user wears a first ring on a finger of a left hand, for example, the user may motion in a downward direction to indicate a cue. It should be appreciated that other user movements may be employed for signaling a cue. The user may then motion, or draw a number, such as “5”, to provide the command of a number. A first sensor device, such as the ring on a users left hand may detect the command of “5” and transmit a command to the display device. A graphical representation will be described in more detail below with respect to FIG. 11A-11B.

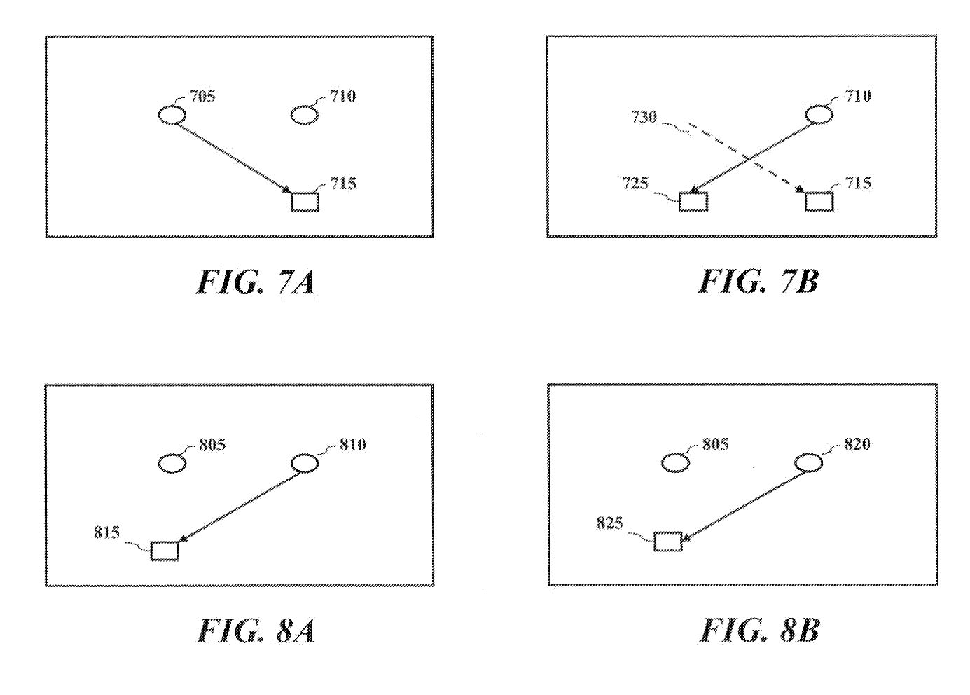

As will be discussed below with reference to FIGS. 7A-7B, 8A-8B, 9, 10, 11A-11B and 12A-12B, graphical representations are depicted for gesture based control. For illustration purposes, gesture based control will be described with reference to a user wearing a first ring on a left hand, and a second ring on a right hand. However, it should be appreciated that other types of positioning sensor devices may be employed. Similarly, it may be appreciated that gesture commands may be generated based on a user wearing two rings on two different fingers of the dame hand, for example.

Referring now to FIGS. 7A-7B, a graphical representation is depicted for gesture based control according to one embodiment. FIGS. 7A-7B depict user motioning of a shape which may be detected to generate a control signal for operation of a device. In particular, FIGS. 7A-7B depict user position of an “X”. FIG. 7A depicts an initial position of a first position sensor, depicted as oval 705, and an initial position of a second sensor, depicted as oval 710. The user gesture of an “X” may be initiated when the user motions a first hand to position 715. Referring now to FIG. 7B, the users right hand is motioned from position 710 to position 725. The initial motion of the users hand is depicted as 730 for illustration purposes. As a result, a device associated with the first sensor may detect positioning of the sensors and determine user motioning of an “X”. The first sensor device may then transmit a command based on the detected gesture.

Referring now to FIGS. 8A-8B, a graphical representation is depicted for gesture based control according to another embodiment. In particular, a gesture command is depicted for a user maintaining a first sensor in a fixed, or relatively fixed position, while motioning a second sensor along a repeated path. As such, a user may provide a gesture for scrolling or navigating a displayed menu. FIG. 8A depicts an initial position of a first position sensor, depicted as oval 805, and an initial position of a second sensor, depicted as oval 810. As depicted a user maintains the first sensor or left hand in a fixed position 805 while moving the second sensor, or right hand from position 810 to position 815. As depicted in FIG. 8B, the user returns the right hand to relatively the same position as previously, depicted as position 820 and motions to position 825. Based on the user positioning the first sensor may generate a command. Based on the number of times the user gestures with the right in as depicted in FIGS. 8a-8B, to a plurality of control commands may be transmitted.

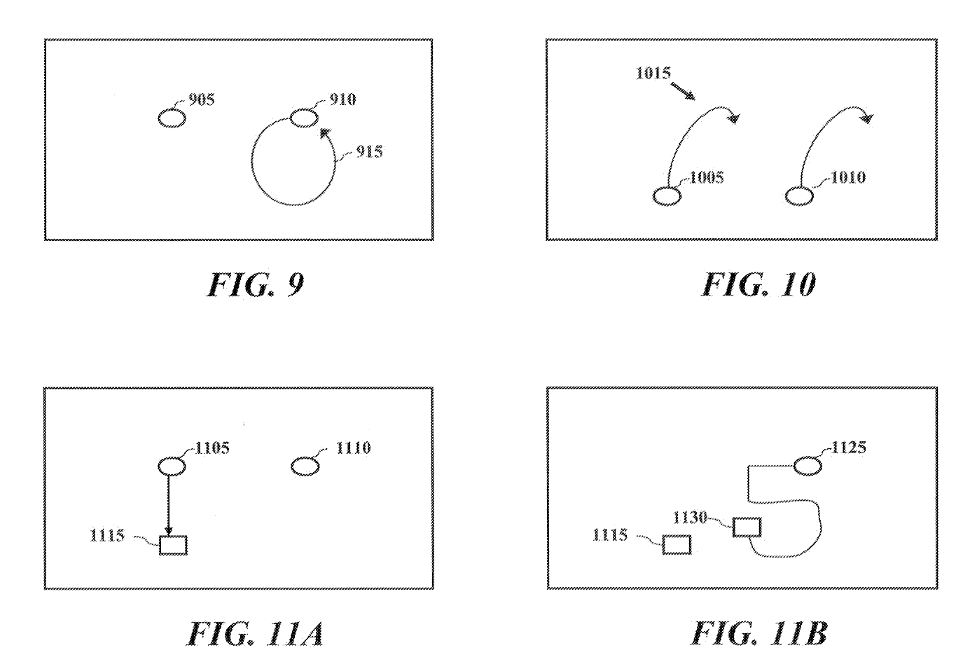

Referring now to FIG. 9, a graphical representation is depicted for gesture based control according to another embodiment. In particular, a gesture command is depicted for a user maintaining a first sensor in a fixed, or relatively fixed position, while motioning a second sensor along a circular path. As such, a user may provide a gesture for enlarging or decreasing size of a display. FIG. 9 depicts an initial position of a first position sensor, depicted as oval 905, and an initial position of a second sensor, depicted as oval 910. As depicted a user maintains the first sensor or left hand in a fixed position 905 while moving the second sensor, or right hand in a circular motion depicted by 915.

Referring now to FIG. 10, a graphical representation is depicted for gesture based control according to another embodiment. In particular, a gesture command is depicted for a user positioning first and second hands in a similar path or direction. As such, a user may provide a gesture changing a display window, or navigating a display cursor. FIG. 10 depicts an initial position of a first position sensor, depicted as oval 1005, and an initial position of a second sensor, depicted as oval 1010. As depicted a user motions the first sensor or left hand along path 1015 while moving the second sensor, or right hand in the same direction and or path.

Referring now to FIGS. 11A-11B, a graphical representation is depicted for gesture based control according to another embodiment. In particular, a gesture command is depicted for a user providing a cue followed by an input command. In order to aide in detection of a command, the user may provide a cue. For example, particular motions may indicate a type of command to be sent. FIGS. 11A-11B are depicted for entering a channel number. FIG. 11A depicts an initial position of a first position sensor, depicted as oval 1105, and an initial position of a second sensor, depicted as oval 1110. As depicted a user motions the first sensor or left hand form fixed position 1105 to a second position depicted as 1115. This motion may relate to a cue. Referring now to FIG. 11B, while maintaining the first sensor, or left hand, in a fixed or relatively fixed position as 1115, the user may then draw or motion a number depicted as the path from 1125 to 1130. Based on the path depicted in FIG. 11B the first sensor device may recognize the number and generate a control signal for a display device. Accordingly, a control signal may be generated for a number drawn.

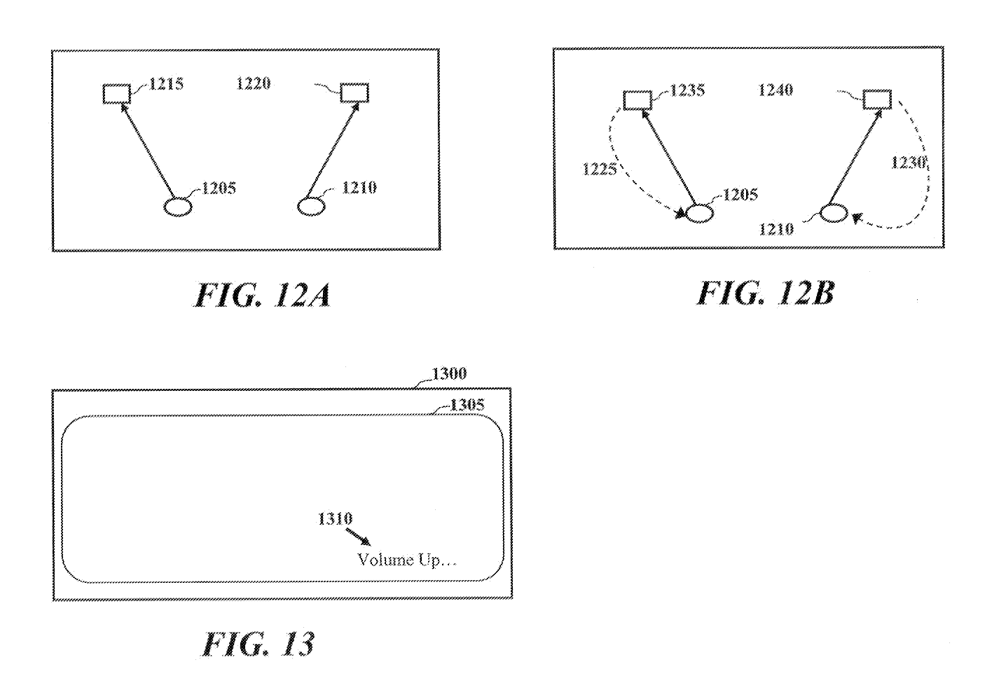

Referring now to FIGS. 12A-12B, a graphical representation is depicted for gesture based control according to another embodiment. In particular, a gesture command is depicted for a user providing an enlarging command. Users employing a display device for network browsing may desire to enlarge the display of a particular portion of the display. Accordingly a gesture may be provided for enlarging and minimizing a view. FIGS. 12A-12B are depicted for motion gin an enlarging command according to one embodiment. FIG. 12A depicts an initial position of a first position sensor, depicted as oval 1205, and an initial position of a second sensor, depicted as oval 1210. As depicted a user motions the first sensor, or left hand, from fixed position 1205 to a second position depicted as 1215 while motioning the second sensor, or right hand, from fixed position 1210 to a second position depicted as 1220. Referring now to FIG. 12B, the user may return the first and second sensor device to relatively the original locations of the gesture as shown by paths 1225 and 1230 and continue to motion the enlarging gesture. Repeating the gesture may result in transmitting an additional command signal to a display device to continue enlarging the display. It should be appreciated that motion the user hands in the opposite direction may relate to generating a command to minimize a display. The gesture described in FIGS. 12A-12B may relate to a dual-motion gesture similar to a dual touch motion on touch-screen devices without requiring the user to touch the display device.

Referring now to FIG. 13, a graphical representation is depicted of a display device operated based on gesture based control. Display device 1300 includes display 1305 which may be configured to display one or more of text and a graphical indicator during and/or after a user transmits a gesture based command. In that fashion, a user may be notified of the particular command transmitted to the device. In certain embodiments, a user may motion a gesture to cancel a previously transmitted command. In certain embodiments the onscreen indicator may be disabled.

While this disclosure has been particularly shown and described with references to exemplary embodiments thereof, it will be understood by those skilled in the art that various changes in form and details may be made therein without departing from the scope of the disclosure encompassed by the appended claims.

What is claimed is:

1. A method for gesture based control of a device, the method comprising the acts of:
detecting a first position sensor signal, the first position sensor signal detected by a first sensor;
detecting a second position sensor signal, the second position sensor signal detected by a second sensor, wherein the second position sensor signal is based on position of the second sensor relative to the first sensor;
generating a control signal for a device based on the first and second position sensor signals, wherein the first and second position sensor signals are generated based on user positing of the first and second sensors; and
transmitting the control signal to the device.

2. The method of claim 1, wherein the first sensor detects motion of the user relative to the device.

3. The method of claim 1, wherein the second sensor detects user positing of the second sensor relative to the first sensor, and wherein a device associated with the second sensor transmits the second position sensor signal to a device associated with the first sensor.

4. The method of claim 1, wherein generating the control signal includes detecting position of the second sensor relative to the first sensor within a plane.

5. The method of claim 1, wherein the first and second sensors are wearable by the user, the first sensor wearable on a first digit of the user, the second sensor wearable on a second digit of the user.

6. The method of claim 1, wherein the control signal is generated based on user positioning of at least one of the first and second sensors with a particular shape.

7. The method of claim 1, wherein the control signal is generated based on user movement of the second sensor while the first sensor is in a fixed position.

8. The method of claim 1, wherein the control signal is generated based on user positioning of the first and second sensors in one of an outward and inward motion relative to each other.

9. The method of claim 1, wherein transmitting the control signal relates to wireless transmission of the control signal from a device associated with the first sensor to the device.

10. The method of claim 1, further comprising displaying an indication by the device based at least in part on the control signal.

11. The method of claim 1, further comprising detecting user tapping of a device associated with the first sensor, and transmitting a control signal to the device based on the tapping.

12. A computer program product stored on computer readable medium including computer executable code for gesture based control of a device, the computer program product comprising:
computer readable code to detect a first position sensor signal, the first position sensor signal associated with a first sensor;
computer readable code to detect a second position sensor signal, the second position sensor signal associated with a second sensor, wherein the second position sensor signal is based on position of the second sensor relative to the first sensor;
computer readable code to generate a control signal for a device based on the first and second position sensor signals, wherein the first and second position sensor signals are generated based on user positing of the first and second sensors; and
computer readable code to transmit the control signal to the device.

13. The computer program product of claim 12, wherein the first sensor detects motion of the user relative to the device.

14. The computer program product of claim 12, wherein the second sensor detects user positing of the second sensor relative to the first sensor, and wherein a device associated with the second sensor transmits the second position sensor signal to a device associated with the first sensor.

15. The computer program product of claim 12, wherein generating the control signal includes detecting position of the second sensor relative to the first sensor within a plane.

16. The computer program product of claim 12, wherein the first and second sensors are wearable by the user, the first sensor wearable on a first digit of the user, the second sensor wearable on a second digit of the user.

17. The computer program product of claim 12, wherein the control signal is generated based on user positioning of at least one of the first and second sensors with a particular shape.

18. The computer program product of claim 12, wherein the control signal is generated based on user movement of the second sensor while the first sensor is in a fixed position.

19. The computer program product of claim 12, wherein the control signal is generated based on user positioning of the first and second sensors in one of an outward and inward motion relative to each other.

20. The computer program product of claim 12, wherein transmitting the control signal relates to wireless transmission of the control signal from a device associated with the first sensor to the device.

21. The computer program product of claim 9, further comprising computer readable code to detect user tapping of a device associated with the first sensor, and to transmit a control signal to the device based on the tapping.

22. A system comprising:
a device;
a first sensor; and
a second sensor, the first sensor configured to
detect a first position sensor signal, the first position sensor signal detected by a first sensor;
receive a second position sensor signal, the second position sensor signal detected by a second sensor, wherein the second position sensor signal is based on position of the second sensor relative to the first sensor;
generate a control signal for a device based on the first and second position sensor signals, wherein the first and second position sensor signals are generated based on user positing of the first and second sensors; and
transmit the control signal to the device.

23. The system of claim 22, wherein the first sensor detects motion of the user relative to the device.

24. The system of claim 22, wherein the second sensor detects user positing of the second sensor relative to the first sensor, and wherein a device associated with the second sensor transmits the second position sensor signal to a device associated with the first sensor.

25. The system of claim 22, wherein generating the control signal includes detecting position of the second sensor relative to the first sensor within a plane.

26. The system of claim 22, wherein the first and second sensors are wearable by the user, the first sensor wearable on a first digit of the user, the second sensor wearable on a second digit of the user.

27. The system of claim 22, wherein the control signal is generated based on user positioning of at least one of the first and second sensors with a particular shape.

28. The system of claim 22, wherein the control signal is generated based on user movement of the second sensor while the first sensor is in a fixed position.

29. The system of claim 22, wherein the control signal is generated based on user positioning of the first and second sensors in one of an outward and inward motion relative to each other.

30. The system of claim 22, wherein transmitting the control signal relates to wireless transmission of the control signal from a device associated with the first sensor to the device.

31. The system of claim 22, further comprising displaying an indication by the device based at least in part on the control signal.

32. The system of claim 22, further comprising detecting user tapping of a device associated with the first sensor, and transmitting a control signal to the device based on the tapping.
